(19) United States
(12) Patent Application Publication
(10) Pub. No.: US 2024/0157440 A1
(43) Pub. Date: May 16, 2024

(54) COMPOSITE MEMBER, PRODUCT, AND METHOD FOR PRODUCING COMPOSITE MEMBER

(71) Applicant: Proterial, Ltd., Tokyo (JP)

(72) Inventors: Shuho KOSEKI, Tokyo (JP); Hiroki SUGAWARA, Tokyo (JP)

(73) Assignee: Proterial, Ltd., Tokyo (JP)

(21) Appl. No.: 18/284,290

(22) PCT Filed: Mar. 23, 2022
(86) PCT No.: PCT/JP2022/013749

§ 371 Date: Sep. 27, 2023

(30) Foreign Application Priority Data
Mar. 30, 2021 (JP) 2021-056502

(51) Int. Cl. B22F 7/02

(52) U.S. Cl. CPC B22F 7/02

(57) ABSTRACT

The present invention provides a composite member, a product, and a method for producing a composite member that make it possible to efficiently improve properties of a member against a load that is not uniform. Provided is a composite member comprising a base material that is made of an alloy, and two or more enhanced-property sections that each include an alloy of a different composition from that of the base material and are disposed so as to be continuous with and integrated with the base material.

### TECHNICAL FIELD

The present invention relates to a composite member, for example, a member suitable for cylinders or screws in tools, mold and die, material extruders, and injection molding machines having excellent durability.

### BACKGROUND ART

It is common that mold and die are imparted with a shape to mold workpiece materials in a desired shape. At this time, normally, mold and die that are used for casting and hot and cold working are composed of a single composition as in the related art. Mold and die come into contact with workpiece materials, receive a variety of loads or impacts and thermal effects depending on shapes or react with workpiece materials and are thereby degraded or damaged. Loads that are applied to mold and die during molding vary with the shapes of the mold and die, and, for example, there are places where a load or an impact is high, the sliding speed is high and the temperature becomes high. In a case where a workpiece material is a molten metal, in a part of the molding surface of mold and die, there are places where degradation significantly progresses due to an influence of the flow rate or the temperature thereof. There are also cases where mold and die are damaged due to scale attached to workpiece materials.

For example, Patent Literature 1 discloses a technique by which the corrosion resistance and wear resistance of an obtained thermally sprayed layer are improved by performing thermal spraying using an alloy powder containing a Mo₂(Ni, Cr)B₂-type complex boride.

### CITATION LIST

### Patent Literature

[Patent Literature 1]
Japanese Patent Laid-Open No. 2009-68052

### SUMMARY OF INVENTION

### Technical Problem

However, only a member composed of a single alloy composition as in the related art or a surface enhancement method in which a cured layer, a film or the like is formed on a member is not sufficient in efficiently improving the properties of the member against a load that is not uniform.

Therefore, an objective of the present invention is to provide a composite member, a product, and a method for producing a composite member that make it possible to efficiently improve properties of a member against a load that is not uniform.

### Solution to Problem

The present invention is a composite member including a base material that is made of an alloy, and two or more enhanced-property sections that each include a different alloy from the base material and are disposed so as to be continuous with and integrated with the base material.

In addition, it is preferable that, in the enhanced-property sections, hardness is 50 HV or more higher or corrosion resistance is 1.2 times or more higher than that in the base material.

In addition, it is preferable that, in the enhanced-property sections, erosion resistance to aluminum is 20% or more higher than that in the base material.

In addition, it is preferable that, in the enhanced-property sections, a thermal conductivity is 5 W/(m·K) or more higher than that in the base material.

In addition, it is preferable that, in the enhanced-property sections, hardness is 200 HV or more.

In addition, for the enhanced-property sections, it is also possible to use at least one alloy selected from a Ni—Cr—Mo-based alloy, a Cr—Mo—Ni—Al-based alloy, a WC—Co-based alloy, a WC—Co—Cu-based alloy, an alloy in which Nb and Mo are contained as a first element group, at least one of Ta, W, Ti, Hf and Zr is contained as a second element group, and, when a total of elements of the first element group and the second element group is set to 100 at. %, a content range of contained elements is 5 to 35 at. %, and a high entropy alloy containing Ni—Cr—Mo. It is preferable that a thickness of a place containing the alloy is 0.1 mm or more.

In addition, the present invention is a product containing the composite member in at least a part.

In addition, it is preferable that the product is a cylinder or a screw in a tool, a mold and die, a material extruder, or an injection molding machine.

In addition, the present invention is a method for producing a composite member including a processing step of processing a base material that is made of an alloy and a building step of obtaining a built component by shaping a property-enhancing material containing a different alloy from the base material on the base material.

### Advantageous Effects of Invention

According to the present invention, it is possible to provide a composite member, a product, and a method for producing a composite member that make it possible to efficiently improve properties of a member against a load that is not uniform.

### BRIEF DESCRIPTION OF DRAWINGS

FIG. 1 is a schematic view of an embodiment of a composite member according to the present invention.

FIG. 2 is a view showing examples of the use of the composite member.

FIG. 3 is a schematic view showing an example of a product of the composite member.

FIG. 4 is a schematic view showing an example of the product of the composite member.

FIG. 5 is a flowchart showing an example of a method for producing a composite member.

FIG. 6 is a schematic view of a composite member produced in an example.

FIG. 7 is a cross-sectional photograph of the composite member produced in the example.

FIG. 8 is a view showing hardness measurement results in the example.

FIG. 9 is a view showing hardness measurement results in the example.

### DESCRIPTION OF EMBODIMENTS

Hereinafter, embodiments of the present invention will be described in detail with reference to drawings. Numerical ranges expressed using “to” in the present specification are regarded as ranges including the front and rear numerical values. In addition, in the drawings, the same or similar portions will be given the same reference signs and will not be described repeatedly. First, a composite member will be described, next, a product and then a method for producing a composite member will be described. A composite member mentioned in the present specification may be a member that is used in contact with a working substance, and an enhanced-property section can be regarded as a section that configures at least a part of a portion in contact with a working substance and forms, for example, a part of the product outline.

(Composite Member)

An embodiment of a composite member according to the present invention is a composite member including a base material that is made of an alloy and two or more enhanced-property sections that each include an alloy of a different composition from that of the base material and are disposed so as to be continuous with and integrated with the base material.

In the composite member of the present embodiment, the composite member in which the base material that serves as a matrix and the two or more enhanced-property sections including a different alloy from the base material are disposed, that is, the configuration in which the enhanced-property sections are disposed on at least a part of the surface of the base material makes it possible to impart a member with arbitrary properties that have been difficult to impart to a member composed of a base material alone. Such a configuration makes it possible to efficiently improve properties of a member against a load that is not uniform.

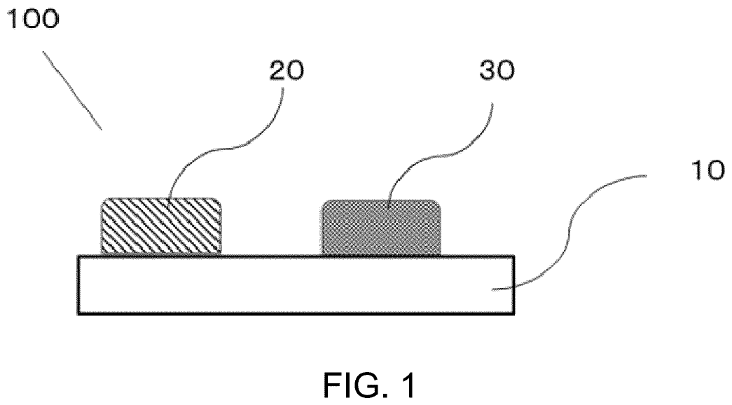

Hereinafter, an embodiment of a composite member 100 according to the present invention will be described using FIG. 1.

As shown in FIG. 1, an embodiment of the composite member has a base material 10 that is made of an alloy and two or more enhanced-property sections 20 and that each include an alloy of a different composition from that of the base material 10 and are disposed so as to be continuous with and integrated with the base material 10.

[Base Material]

The base material 10 is not particularly limited, and a variety of metal materials can be used. For example, it is possible to use Fe-based alloys, Ni-based alloys, Ti-based alloys and cemented carbides, more specifically, alloy tool steel for a hot mold and die that is used in die casting or the like, alloy tool steel for a cold mold and die that is used in press molding, high-speed tool steel that is used in cutting or the like, alloys for an extrusion mold and die that is used in extrusion molding, steel for a plastic mold that is used in plastic molding, general steel, stainless steel, and the like.

More specific examples thereof include, as steel types, SKD61, maraging steel, SKD11, SKH51, SCM440, S50C, SUS316L, Alloy 718, Stellite 6 (registered trademark of Kennametal Inc.), Ti6Al4V, and the like.

[Enhanced-Property Section]

The enhanced-property sections 20 and 30 are alloys that are disposed on the base material 10 for the purpose of locally enhancing (improving) the properties of the base material 10, which is a matrix. The enhanced-property sections have different properties from the base material. As the two or more enhanced-property sections, alloys having the same material or properties may be disposed, respectively, or alloys having a different material or different properties for each enhanced section may be disposed.

Properties mentioned in the present specification refer to, for example, wear resistance, corrosion resistance, thermal conductivity, erosion resistance, and heat resistance. The alloys are not particularly limited as long as the alloys are capable of enhancing these properties, but preferably have higher hardness (HV) by 50 HV or more and higher corrosion resistance by 1.2 times or more than the base material. In addition, the corrosion resistance is preferably twice higher and more preferably three times higher than that of the base material. In addition, the hardness (HV) of the enhanced-property sections is preferably 200 HV, more preferably 300 HV or higher, and still more preferably 400 HV or higher. Furthermore, the alloys are more preferably capable of enhancing two or more properties among the above-described properties. In addition, the thicknesses of the enhanced-property sections are preferably 0.1 mm or more. The enhanced-property sections are not normal coating layers having a uniform thickness and preferably configure a partial portion of the composite member having a nonuniform thickness. That is, the enhanced-property sections configure at least a part of a portion that comes into contact with a working substance or the like and are capable of forming, for example, a part of the outline of a product.

Hereinafter, the alloys configuring the enhanced-property sections will be exemplified.

<WC—Co-Based Alloy>

A cemented carbide containing WC and Co as main components (hereinafter, referred to as the WC—Co-based alloy) is an example of the alloys configuring the property-enhance sections. The hardness of the WC—Co-based alloy can be adjusted by changing the amounts of WC, which is a hard phase, and Co, which is a metal, and, when the amount of Co is 10 mass %, and the amount of Co is 40 mass %, the hardness is approximately 450 HV to 1500 HV. Similarly, the hardness of TiC—Ni-based cermet materials can also be adjusted by changing the amount of Ni, which is a metal. In addition, hard cermets which contain a carbide, nitride, boride, carbonitride, oxide and oxynitride of a Group 4, 5 or 6 transition metal as a hard phase and allows the hardness of materials composed of a metal and the cermet to be adjusted, and thus are preferable as the alloys configuring the enhanced-property sections.

In addition, a Ni-based alloy containing Cr and Mo (hereinafter, referred to as Ni—Cr—Mo-based alloy), which is capable of enhancing wear resistance and corrosion resistance, is an example of the alloys. The Ni—Cr—Mo-based alloy is a Ni-based alloy in which, in terms of mass ratio, the content of Ni is the largest and is followed by the contents of Cr and Mo. For example, alloys obtained by adding Ta and B, C or WC as minor configuration elements to a Ni—Cr—Mo-based alloy as described below are preferable.

<Alloy Obtained by Adding B to Ni—Cr—Mo-Based Alloy>

A Ni—Cr—Mo-based alloy containing B as a minor configuration element is a Ni-based alloy in which, in terms of mass ratio, the content of Ni is the largest and is followed by the contents of Cr and Mo and contains Cr, Mo and Ni as principal configuration elements and Ta and B as minor configuration elements. For example, regarding the principal configuration elements, it is preferable that the content of Ni is the largest and Cr and Mo are contained, by mass %, within ranges of Cr: 18% to 22% and Mo: 18% to 39%. In addition, it is preferable that the minor configuration elements of Ta and B are contained, by mass %, within ranges of Ta: 1.5% to 2.5% and B: 1.0% to 2.5%. The content of Ni is regulated as the balance with respect to Cr, Mo, Ta and B.

<Alloy Obtained by Adding C to Ni—Cr—Mo-Based Alloy>

In a Ni—Cr—Mo-based alloy containing C as a minor configuration element, it is preferable that, for example, by mass %, Cr: 18% to 22%, Mo: 18% to 28%, Ta: 1.5% to 57%, and C: 1.0% to 2.5%, Nb: 0% to 42%, Ti: 0% to 15%, V: 0% to 27%, and Zr: 0% to 29% are contained, the balance is Ni and an inevitable impurity, and, by mole ratio, (Ta+0.7Nb+Ti+0.6V+Zr)/C=0.5 to 1.5 is satisfied. In the case of being formed as an enhancing phase, the alloy is, for example, an additive Manufactured product (simply referred to as a built component in some cases) or casting having a solidified structure, and the solidified structure has a metal phase that is a face-centered cubic lattice structure and a carbide and has a dendrite crystal structure.

<Alloy Obtained by Adding WC to Ni—Cr—Mo-Based Alloy>

As a Ni—Cr—Mo-based alloy containing WC as a minor configuration element, it is possible to use, for example, an alloy in which, by mass %, Cr: 8.5% to 23.0%, Mo: 8.5% to 27.0%, Ta: 0.5% to 2.5%, W: 15.0% to 51.0%, and C: 1.0% to 3.5% are contained, the balance is Ni and an inevitable impurity, and the mass ratio of Ni, Cr, and Mo is 2.5 to 3.5:1:1.0 to 1.5 (Ni:Cr:Mo).

<MoCr-NiAl-Based Alloy>

In addition, it is possible to use, for example, an alloy containing Cr, Mo, Ni and Al as top four element having large contents (MoCr—NiAl-based alloy), which is capable of enhancing wear resistance and erosion resistance. In the alloy composition, in a case where erosion resistance matters, the following chemical composition I can be adopted, and, in a case where improvement in scuffing resistance attributed to high hardness or a decrease in the melting point of the alloy composition matters, the following chemical composition II can be adopted.

[Chemical Composition I]

When Mo+Cr+Ni+Al is set to 100 at. %, Ni+Al=15 to 50 at. %, and Mo+Cr=50 to 85 at. %.

[Chemical Composition II]

When Mo+Cr+Ni+Al is set to 100 at. %, Ni+Al=40 to 70 at. %, and Mo+Cr=30 to 60 at. %.

In a case where the chemical composition I is adopted, it is preferable that Ni is 7.5 to 25 at. %, Al is 7.5 to 25 at. %, Cr is 10 to 25 at. %, and the remainder is Mo and an inevitable impurity.

In a case where the chemical composition II is adopted, it is preferable that Ni is to 35 at. %, Al is 20 to 35 at. %, Cr is 10 to 50 at. %, and the remainder is Mo and an inevitable impurity.

The chemical compositions I and II overlap in some ranges. It is most preferable to set these overlapping ranges, that is, Ni+Al=40 to 50 at. % and Mo+Cr=50 to 60 at. % from the viewpoint of improvement in erosion resistance and hardness and a decrease in the melting point of the alloy composition.

<WC—Co—Cu-Based Alloy>

In addition, it is possible to use, for example, an alloy obtained by adding Cu to a WC—Co-based alloy (WC—Co—Cu-based alloy), which is capable of enhancing wear resistance and thermal conductivity. As an alloy capable of enhancing wear resistance and thermal conductivity, preferable is an alloy containing WC particles, Cu, and a metallic bond phase composed of at least one of Co, Fe and Cr, in which the content of the WC is 40 mass % or more, the content of at least one of the Co, Fe, and Cr is 25 mass % or more and less than 60 mass %, and the ratio a/b of the content a of the Cu to the content b of at least one of the Co, Fe, and Cr satisfies 0.070≤a/b≤1.000. According to the WC—Co—Cu-based alloy, since the thermal conductivity can be estimated to be 40 W/(m·K) or more, a higher thermal conductivity than that of the base material can be realized, and, specifically, a higher thermal conductivity by 5 W/(m·K) or more than that of the base material can be realized, which is preferable.

<High Entropy Alloy>

In addition, it is possible to use, for example, a high entropy alloy (HEA), which is an alloy of a novel technical concept that is totally distinctive from the technical concept of alloys obtained by adding a small amount of a plurality of minor component elements to one to three principal component elements. HEA is defined as an alloy composed of five or more principal component elements (5 to 35 at. % each) and is an alloy having excellent mechanical properties and corrosion resistance and, furthermore, having improved hardness and wear resistance.

In addition, the alloy concept of a multi-principal element alloy (MPEA) having a plurality of principal elements but allowing the presence of multiple phases also has been proposed; however, in the present application, HEA and MPEA are handled as the same concept, and both will be collectively referred to as HEA. When each element of Co, Cr, Fe, Ni and Ti is contained in a range of 5 at. % or more and 35 at. % or less, Mo is contained in a range of more than 0 at. % and 8 at. % or less, and the balance is an inevitable impurity in the alloy, it is possible to obtain a material having excellent softening resistance by adding an aging treatment or the like after build-up shaping.

<Powder High-Speed Tool Steel>

In addition, it is possible to use, for example, powder high-speed tool steel that is a high carbon-based alloy and contains a carbide-forming element such as Cr, W, Mo, V or Co, which is capable of enhancing wear resistance and heat resistance. It is preferable that, by mass %, C is 0.3% to 2.8%, Cr is 3.0% to 10.0%, W is 1.5% to 10.5%, Mo is 2.0% to 9.0%, V is 1.0% to 8.0%, and the remainder is Fe and an inevitable impurity.

<High-Melting Point Metal>

It is possible to use, for example, high-melting point metal, which is capable of enhancing wear resistance and erosion resistance. The high-melting point metal is, for example, W, Ta, Nb, Mo or the like. The use of the high-melting point metal makes it possible to enhance erosion resistance to aluminum. That is, it is possible to dispose enhanced-property sections having higher erosion resistance to aluminum than that of the base material and to realize, for example, higher erosion resistance to aluminum by 20% or more than that of the base material, which is preferable.

(Action and Effect)

The composite member in which the base material that serves as a matrix and the two or more enhanced-property sections including a different alloy from the base material are disposed, that is, the configuration in which the enhanced-property sections are disposed on at least a part of the surface of the base material makes it possible to impart a member with arbitrary properties that have been difficult to impart to a member composed of a base material alone. Such a configuration makes it possible to efficiently improve properties of a member against a load that is not uniform.

(Properties)

Here, hardness (HV) in the present specification can be, for example, a value measured with a Vickers hardness tester itself or a value obtained by conversion from a value measured with a variety of hardness testers for Rockwell hardness, Shore hardness and the like. In addition, erosion resistance to aluminum refers to, for example, a state where a change in mass is small compared with the amount of SKD61 reduced per unit time at the time of evaluating the amount of the mass reduced when a test material has been immersed in molten Al for a certain time. In addition, corrosion resistance may be, for example, a value obtained as follows: each material under test (alloy member) is cut into 10 mm×10 mm×2.5 mm, and the entire surface of a test piece is polished with waterproof emery paper up to #1000, then, degreased with acetone and ethanol, and subjected to a corrosion test. Each test piece is immersed for 24 hours in 10% H₂SO₄ that has been boiled, then, the test piece is removed from an etchant, the mass of each test piece is measured, and the corrosion rate is obtained from a change in mass. In addition, the corrosion form of the appearance of the test piece may be observed with a scanning electron microscope (SEM). In addition, a thermal conductivity is, for example, a value measured by flash method or horizontal Bridgman.

[Intermediate Layer]

In addition, it is preferable to provide, for example, an intermediate layer between the base material and the enhanced-property section. In a case where the enhanced-property section, which is a dissimilar material with respect to the base material, is joined to the base material, when a buffer area called an intermediate layer is provided, it is possible to make it less likely for cracking, deformation, peeling or the like arising from a difference in properties between the base material and the enhanced-property section. The intermediate layer is preferably an austenite-based material having high toughness, and, for example, a Ni-based superalloy, an austenite-based stainless steel alloy or pure Ni is preferable.

(Product)

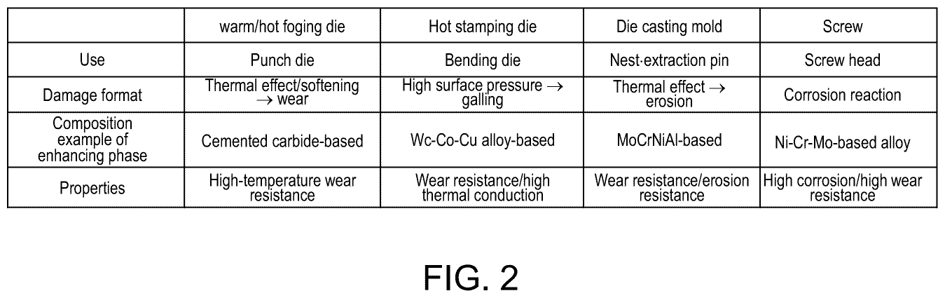

An embodiment of a product for which the above-described composite member is used will be described using FIG. 2 to FIG. 4. For example, the product can be applied to uses as shown in FIG. 2. In the present specification, as examples of the product for which the composite member is used, the cases of a mold and die for warm forging, a screw for an injection mold and die, a hot stamping mold, and a stirrer will be described, but the use is not limited thereto. For example, the composite member is suitable for cylinders or screws in a variety of tools such as a cutting tool for removal processing, a mold and die for plastic processing, a jig and a tool such as a cutting blade or a die cut roll, mold and die, material extruders, and injection molding machines.

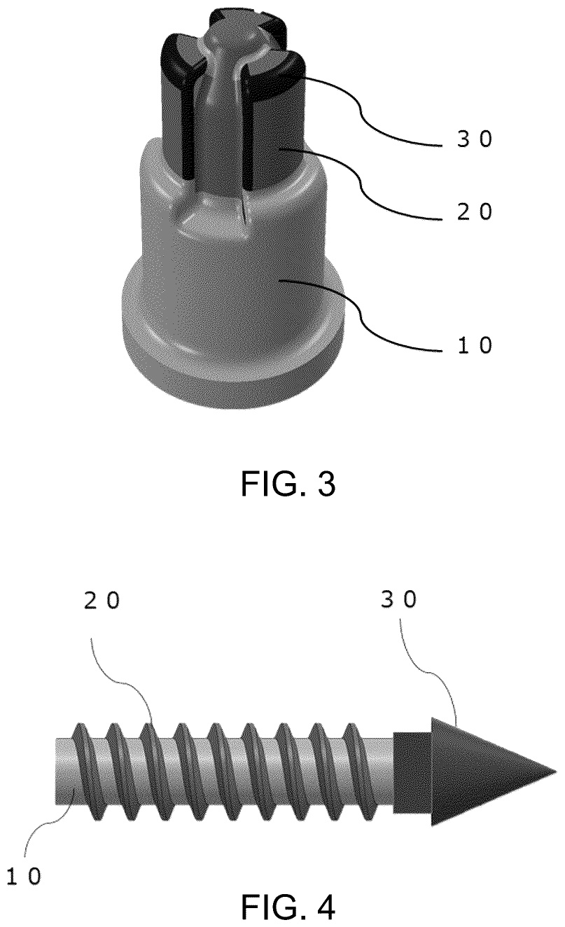

The die for warm forging is a product required to have wear resistance at high temperatures and toughness for withstanding impacts during forging. FIG. 3 shows a schematic view showing an example of the product for which the composite member is used (warm forging punch). For the base material 10, YXR33 (manufactured by Hitachi Metals, Ltd., YXR is registered trademark), which is a matrix high-speed tool steel, can be used, for the enhanced-property section 20 enhancing properties, WC-20% Co can be used, and, for the enhanced-property section 30, WC-40% Co can be used.

As a method for producing the product shown in FIG. 3, a matrix high-speed tool steel (as-quenched material) satisfying both hardness and toughness can be used for the base material 10. Next, grooving is performed on each of a portion that is likely to be worn by friction in a high-temperature and high-pressure environment during forging and a portion that is likely to be cracked by impact, and WC-20% Co having excellent wear resistance and WC-40% Co having excellent toughness are added thereto, respectively, by powder build-up shaping. As a heat source during powder build-up, a laser, plasma and the like can be used. The member surface after the powder build-up shaping is cut, and a shape is arranged, whereby a product having a plurality of enhanced-property sections and being composed of a plurality of materials is obtained. In addition, a surface treatment may be further performed on this product.

In addition, FIG. 4 shows a schematic view of the case of a screw for an injection mold as an example of the product for which the composite member is used. The screw for an injection mold is a product required to have wear resistance and corrosion resistance. For the base material 10, YPT42 (manufactured by Hitachi Metals, Ltd., YPT is registered trademark) (hardness: 58HRC), which is stainless steel and is used for small or medium screws or screw front end components, can be used, for the enhanced-property section 20 enhancing properties, a high entropy alloy (26.7Cr-18.0Fe-26.9Ni-8.9Ti-1.8Mo mass %) can be used, and, for the enhanced-property section 30, an alloy obtained by adding C to a Ni—Cr—Mo-based alloy (46.7Ni-19.0Cr-19.0Mo-1.8Ta-12.0Nb-1.5C mass %) can be used.

First, the rod-like base material 10 is prepared using YPT42 having hardness and corrosion resistance. Next, a fin-shaped section that is provided on the outer circumferential surface of the base material 10, that is, the enhanced-property section 20 enhancing properties, is configured. For example, the enhanced-property section may be produced by additive manufacturing a high entropy alloy powder to the outer circumferential surface of the base material 10. The high-entropy alloy has superior corrosion resistance to YPT42 and is thus effective for suppressing wear attributed to corrosion. In addition, the enhanced-property section 30 is produced by adding an alloy obtained by adding carbon (C) to a Ni—Cr—Mo-based alloy to one end of the base material 10, that is, a place that will become a screw part. The screw part needs to have high wear resistance than the fin-shaped section, and thus it is effective to apply an alloy obtained by additive manufacturing C to a highly corrosion-resistant Ni—Cr—Mo-based alloy in which hard particles (NbC) are dispersed.

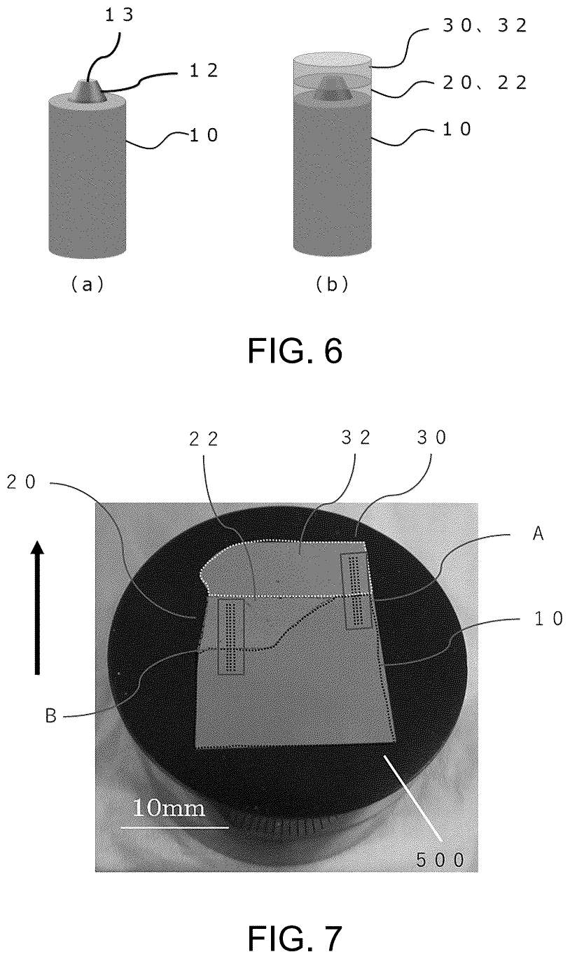

A stirrer for stirring an oxidizing liquid in a state where a solid matter has been precipitated or floated is a product required to have corrosion resistance and wear resistance. FIG. 6 shows a schematic view showing an example of the composite member. For a place A that will become the base material, YAG300 (Hitachi Metals, Ltd., YAG is registered trademark), which is a 18% Ni maraging steel and is used for motor cases of rockets and the like, can be used. Particularly, at the front end of the stirrer, since corrosion by the oxidizing liquid becomes a problem, an enhanced section needs to be produced by adding, for example, MAT21 (manufactured by Hitachi Metals, Ltd., MAT21 is registered trademark), which is a highly corrosion-resistant Ni-based alloy, to a place B.

In addition, on the side surface of the stirrer, since wear by an impurity deposited in the oxidizing liquid becomes a problem, an enhanced section needs to be produced by adding, for example, a CoCrFeNiTiMo-based high entropy alloy satisfying both a high strength and high corrosion resistance to a place C. The member surface after the powder build-up shaping is cut, and a shape is arranged, whereby a product having a plurality of enhanced-property sections and being composed of a plurality of materials is obtained. A surface treatment such as ceramic coating may be further performed on this product by a PVD method or a CVD method.

In a die that is used for hot stamping, quenching is performed by removing heat from a workpiece material with a die cooled with water at the same time as the pressing of the heated workpiece material, thereby improving the strength of the workpiece material. The die is required to have a heat removal action. The die has been cooled with water, but there is a demand for the thermal conductivity of a material configuring a part between the base material in which a water cooling hole is disposed and the die surface to be high. The disposition of a highly thermally conductive material shortens the time taken to remove heat and also improves productivity.

In addition, the workpiece material that has been cooled and quenched has high hardness, and thus galling occurs at the time of removing the workpiece material from the die. Therefore, the surface of the die is also required to have high hardness. Heat removal properties and wear resistance can be provided by performing grooving up to the vicinity of the water cooling hole and using an alloy having a high thermal conductivity and hardness (WC-30% Co-5Cu wt %). In addition, there is a portion in the workpiece material where a wrinkle is formed during forging, and, in this portion, a local seizing or galling phenomenon occurs. For improvement in wear resistance, it is effective to add and produce a WC-15% Co alloy or the like having higher hardness to and on such a place.

(Method for Producing Composite Member)

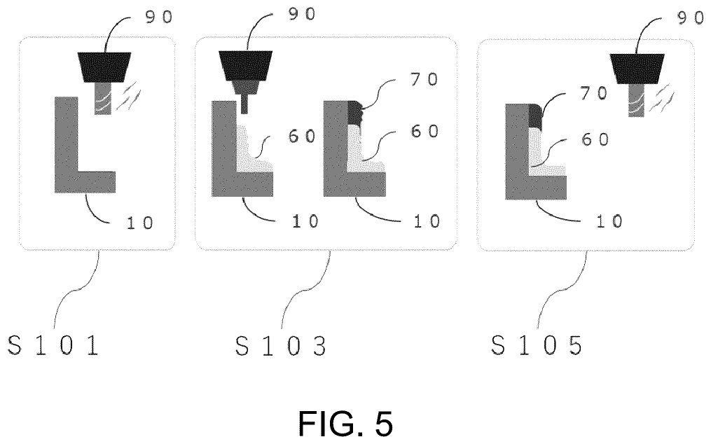

An embodiment of a method for producing a composite member will be described using FIG. 5. The embodiment of the method for producing a composite member is a method for producing a composite member including a processing step of processing a base material that becomes a matrix and a building step of obtaining a built component by shaping a property-enhancing material containing a different alloy from the base material on the base material as shown in FIG. 5.

The processing step (S101) is a step of processing the base material 10 into a desired shape, and the base material needs to be processed into a desired shape using, for example, a processing tool 90 or the like. Next, in the building step (S103), a built component may be produced by adding a property-enhancing material 60 and a property-enhancing material 70 to the base material 10 using the above-described alloy-based alloy powder (property-enhancing material) depending on a characteristic that is intended to be imparted. An addition method is not particularly limited, and, for example, thermal spraying or additive manufacturing (laminate shaping) method can be used.

After the building step, a finishing step (S105) or a thermal treatment step may be additively performed. The finishing step (S105) is a step of obtaining a product by processing the built component obtained in the building step (S103) into a desired shape, and a product can be obtained by, for example, machining the built component into a desired shape. The thermal treatment step is a step of thermally treating the obtained built component or product.

The additive manufacturing method will be described in detail.

In the additive manufacturing method, an alloy powder is supplied, a region where the power is laid is irradiated with high energy such as laser beams or electron beams to selectively melt and bond the alloy powder, whereby a built component having a desired shape (composite member) can be shaped. Additive manufacturing devices can be classified into a powder bed fusion (PBF)-type device and a directed energy deposition (DED)-type device depending on the shape or the like of the built component, but the composite member of the present embodiment can be shaped with any type of device, and there is no particular limitations on the format or the like of additive manufacturing devices.

In addition, there is a shaping method in which a shape is imparted by repeatedly melting and solidifying each powder; however, when the particle diameters of the alloy powder are less than 1 μm, it becomes difficult to obtain a volume necessary for a single round of melting and solidification, and thus it is difficult to obtain a sound built component. On the other hand, when the particle diameters of the alloy powder exceed 100 μm, the volume necessary for a single round of melting and solidification is too large, and it is difficult to obtain a sound built component. Therefore, the range of the particle diameters of the alloy powder is preferably set to 1 to 200 μm. The range is more preferably 20 to 100 μm. In addition, a powder obtained by a gas atomization method from which a spherical shape can be obtained is preferable. The particle diameters of the powder can be measured using a laser diffraction particle size analyzer, and, in a cumulative distribution curve showing the relationship between the particle diameter and the volume accumulation from the small particle diameter side, a particle diameter corresponding to a powder cumulative frequency of 50 vol % can be regarded as d50.

### EXAMPLES

A produced composite member will be described using FIG. 6. As shown in FIG. 6(a), as a base material 10, a base material having a base material side surface part 12 and a base material front end part 13 was prepared. In addition, as shown in FIG. 6(b), two kinds of metal powders were added to and produced on each of the places of an enhanced-property section 20 and an enhanced-property section 30 on the base material 10, thereby producing a composite member. Specifically, a composite member in which, on YAG300 (manufactured by Hitachi Metals, Ltd.), which is a 18% Ni maraging steel, used as the base material 10, an alloy powder of MAT21, which is a Ni—Cr—Mo alloy, as a property-enhancing material 32 for enhancing the base material front end part 13 was disposed at the base material front end part 13 and an alloy powder of HiPEACE (manufactured by Hitachi Metals, Ltd., HiPEACE is registered trademark), which is a high entropy alloy, as a property-enhancing material 22 for enhancing the base material side surface part 12 was disposed at the base material side surface part 12, respectively, was produced using an additive manufacturing method.

The composition of MAT21 used as the property-enhancing material 32 is shown in Tables 1 and 2. The particle size is the value of d50 and was 80.344 μm. The composition of HiPEACE used as the property-enhancing material 22 is shown in Table 3. The particle size is the value of d50 and was 88.418 μm.

TABLE 1
(mass %)

| Ni | Cr | Mo | Ta |
|---|---|---|---|
| Bal. | 19.17 | 18.68 | 1.74 |

TABLE 2
(mass %)

| C | Si | Mn | P | S | Co | Fe | V | Al | N | O |
|---|---|---|---|---|---|---|---|---|---|---|
| 0.0072 | <0.01 | <0.01 | 0.001 | 0.0002 | <0.01 | <0.01 | <0.01 | 0.005 | 0.0007 | 0.0117 |

TABLE 3
(mass %)

| Cr | Fe | Ni | Ti | Mo | Co | C | S | N | O |
|---|---|---|---|---|---|---|---|---|---|
| 18.44 | 14.39 | 23.64 | 7.39 | 3.89 | Bal. | 0.011 | 0.0002 | 0.0004 | 0.00021 |

Here, before the property-enhancing material 22 and the property-enhancing material 32 were added to and produced on the base material 10, grooving was applied to the places planned for additive manufacturing. Regarding processing conditions, a four-blade coated cemented carbide tool was prepared, the cutting speed was set to 25 m/min, the single blade feed rate was set to 0.05 mm/tooth, and a surface layer part of the base material 10 was removed.

In the additive manufacturing type, a directed energy deposition-type device was used. Regarding shaping conditions, the output was set to 2400 W, and the scanning speed was set to 1000 mm/m.

The hardness of the produced composite member was measured. As shown in FIG. 7, the hardness was measured using a sample 500 obtained by cutting, polishing and implanting the produced composite member in a resin. Test pieces for hardness measurement were collected from, in the sample 500, an A point surrounded by a solid line to measure hardness transition from the base material 10 to the front end-enhanced section 30 and a B point surrounded by a solid line to measure hardness transition from the base material 10 to the side surface-enhanced section 20.

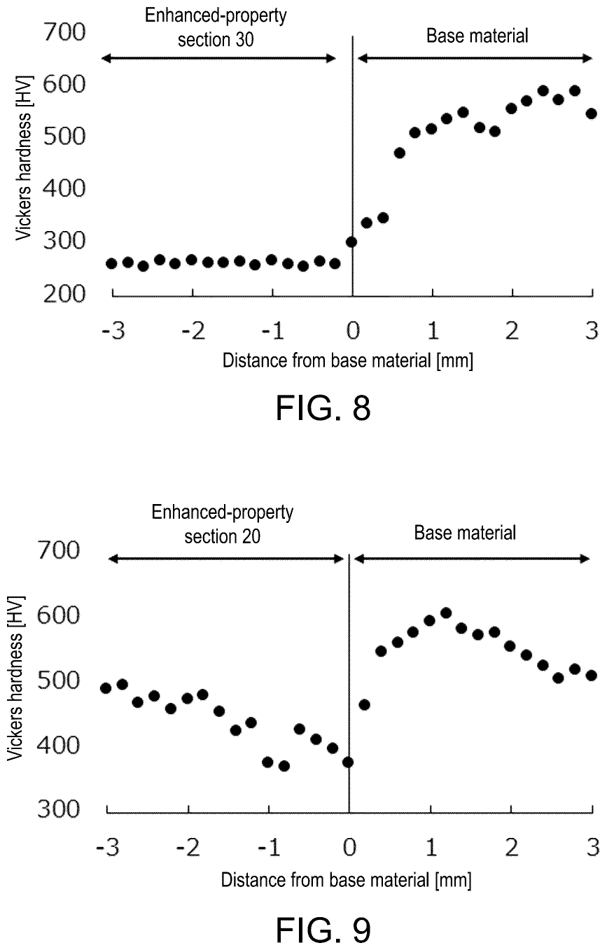

FIG. 8 shows the results of a Vickers hardness measurement test on the place of the A point shown in FIG. 7, and FIG. 9 shows the results of a Vickers hardness measurement test on the place of the B point shown in FIG. 7. As shown in FIG. 7, the Vickers hardness was measured using a micro Vickers on the A point and the B point of the test piece. The solid lines shown in FIG. 8 and FIG. 9 indicate the surface position of the base material, and the hardness was measured in a region from the surface of the base material, that is, the solid line as a basis to a place 3 mm apart in each of the shaping direction and a direction opposite to the shaping direction. The measurement intervals were set to 200 μm. The hardness was measured along three lines shifted 300 μm from each other, and the average was calculated. The measurement conditions were as described below.
Device name: FM-110ARS-F (manufactured by Future-Tech Corp.)
Test load: 0.1 kgf
Retention time: 10 seconds

(Results)

As shown in FIG. 8, compared with the base material 10, the hardness of the enhanced-property section 30 where the property-enhancing material 32 has been additive manufactured becomes low, that is, it can be said that the toughness has improved. Since the property-enhancing material 32 is a highly corrosion-resistant Ni-based alloy, improvement in the corrosion resistance of the enhanced-property section 30 where the property-enhancing material 32 has been additively shaped can be expected.

In addition, as shown in FIG. 9, the hardness has varied in the base material 10 and in the place where the property-enhancing material 22 has been additively shaped. Since the property-enhancing material 22 is a high-strength and highly corrosion-resistant alloy, improvement in the strength and corrosion resistance of the enhanced-property section 20 that has been additive manufactured can be expected.

Based on what has been described above, in a case where the composite member of the present example is applied to, for example, a stirrer for stirring an oxidizing liquid in a state where a solid matter has been precipitated or floated, the base material front end part is capable of suppressing corrosion by the oxidizing liquid, and the base material side surface part is capable of suppressing wear by an impurity deposited in the oxidizing liquid, and thus it becomes possible to efficiently improve properties of a member against a load that is not uniform.

### REFERENCE SIGNS LIST

10 Base material
12 Base material side surface part
13 Base material front end part
20 Enhanced-property section
22 Property-enhancing material
30 Enhanced-property section
32 Property-enhancing material
60 Property-enhancing material
70 Property-enhancing material
90 Processing tool
100 Composite member
500 Sample
S101 Processing step
S103 Building step
S105 Finishing step

1. A composite member, comprising:
a base material that is made of an alloy; and
two or more enhanced-property sections that each include an alloy of a different composition from that of the base material and are disposed so as to be continuous with and integrated with the base material.

2. The composite member according to claim 1,
wherein, in the enhanced-property sections,
hardness is 50 I-IV or more higher or corrosion resistance is 1.2 times or more higher than that in the base material.

3. The composite member according to claim 1,
wherein, in the enhanced-property sections,
erosion resistance to aluminum is 20% or more higher than that in the base material.

4. The composite member according to claim 1,
wherein, in the enhanced-property sections,
a thermal conductivity is 5 W/(m·K) or more higher than that in the base material.

5. The composite member according to claim 1,
wherein, in the enhanced-property sections,
hardness is 200 HV or more.

6. The composite member according to claim 1,
wherein the enhanced-property sections are at least one alloy selected from a Ni—Cr—Mo-based alloy, a Cr—Mo—Ni—Al-based alloy, a WC—Co-based alloy, a WC—Co—Cu-based alloy, or a high entropy alloy containing Ni—Cr—Mo, and
the enhanced-property sections have a thickness of 0.1 mm or more.

7. A product, comprising:
the composite member according to claim 1 in at least a part.

8. The product according to claim 7 that is a cylinder or a screw in a tool, a mold and die, a material extruder, or an injection molding machine.

9. A method for producing a composite member, comprising:
a processing step of processing a base material that is made of an alloy; and
a building step of obtaining a built component by shaping a property-enhancing material containing an alloy of a different composition from that of the base material at two or more places on the base material.
